(19) United States
(12) Patent Application Publication
(10) Pub. No.: US 2018/0009999 A1
(43) Pub. Date: Jan. 11, 2018

(54) Continuous Electrodeposition of a Coating on Metal Sheet Stock

(71) Applicant: PPG Industries Ohio, Inc., Cleveland, OH (US)

(72) Inventors: Hanzhen Bao, Mason, OH (US); Youssef Moussa, Loveland, OH (US); Alton B. Wilson, West Chester, OH (US)

(21) Appl. No.: 15/711,413

(22) Filed: Sep. 21, 2017

Related U.S. Application Data
(62) Division of application No. 14/807,960, filed on Jul. 24, 2015.

(51) Int. Cl. C09D 5/44; C25D 13/22; C25D 13/16

(52) U.S. Cl. CPC C09D 5/4465; C25D 13/16; C25D 13/22

(57) ABSTRACT

Electrodeposition of coil metal sheet stock using an aqueous dispersion of a poly(urethane-carbonate) is disclosed. The coated sheet stock can be used in forming coated metal cans.

### CROSS-REFERENCE TO RELATED APPLICATION

This application is a divisional of application Ser. No. 14/807,960, filed Jul. 24, 2015.

### FIELD OF THE INVENTION

The present invention relates to the continuous electrodeposition of a coating onto metal sheet stock, such as that from a metal coil. More specifically, the present invention relates to the continuous electrodeposition of a coating onto metal sheet stock and forming a can body or can end from the coated metal sheet stock.

### BACKGROUND OF THE INVENTION

Coil coating involves the coating of a continuous length of metal sheet stock. The sheet, which is usually thin gauge steel or aluminum, is usually coiled over a spool which is continuously unwound and passed to a coating station where the sheet is coated in a continuous manner as it passes through the station. At the coating station, which is usually a roll coater or spray coater, a coating is applied and the coated substrate is then passed to a baking oven for curing.

There are a number of disadvantages associated with spray and roll coat applications. Uniform thickness over the length of the coil is difficult to obtain and the coating has poor green strength because of retained diluent. Consequently, the coating often sticks to the various rollers that convey the coated coil through the coating process.

It has been proposed to apply the coating to the metal coil by the electrodeposition process that would provide uniform thickness with good green strength because of electrical endosmosis that occurs during the electrodeposition process. However, it is difficult to obtain a resinous binder for the coating that has high electrodeposition efficiency and also provides good coating properties for the end use desired. This is particularly true for coatings for metal cans, particularly the interior of metal cans where the coating must have flexibility, corrosion resistance and solvent resistance to meet the demands of the can-forming operation and the demands of protecting the food or beverage in the cans from spoilage. The present invention provides a resinous binder that meets these various demands.

### SUMMARY OF THE INVENTION

The present invention provides a method for electrocoating a continuous length of flat metal sheet comprising:
(a) withdrawing the flat metal sheet from a supply source and continuously
(b) passing the sheet into an aqueous electrodeposition bath that contains as an electrocoating vehicle a salt of a poly(urethane-carbonate),
(c) electrodepositing a coating of the poly(urethane-carbonate) as the sheet passes through the electrodeposition bath to form a coated sheet,
(d) passing the coated sheet through a curing station to form a cured coating,
(e) leading the sheet with the cured coating to a point of accumulation.

The coated metal sheet can be taken from the point of accumulation, cut into metal sheets and the sheets formed into a food or beverage container or a part thereof, such as a can end.

The invention also provides for an article comprising:
(a) a metal food or beverage container including a portion thereof, and
(b) a coating composition applied to a surface of the container, the coating composition comprising an aqueous poly(urethane-carbonate) dispersion.

### BRIEF DESCRIPTION OF THE DRAWINGS

FIG. 1 is a schematic drawing showing the continuous electrocoating method of the invention.

FIG. 2 is an elevated cross-sectional view of an electrodeposition tank for practicing the method of the invention.

### DETAILED DESCRIPTION

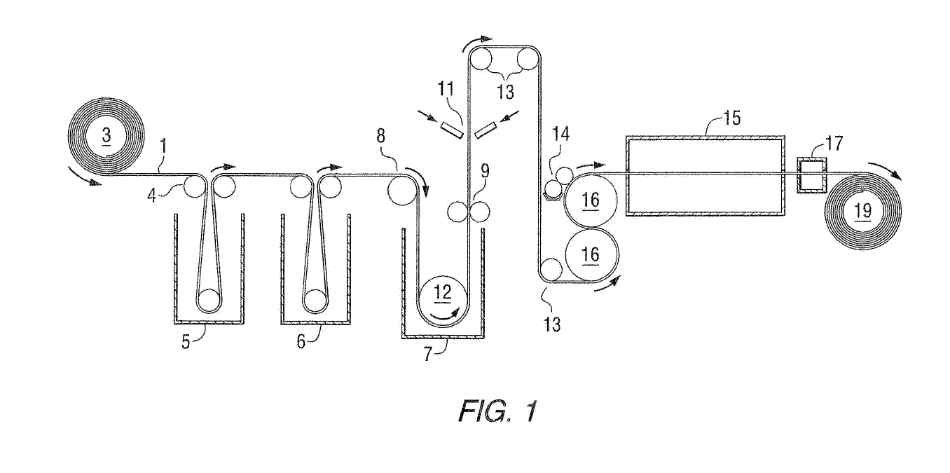

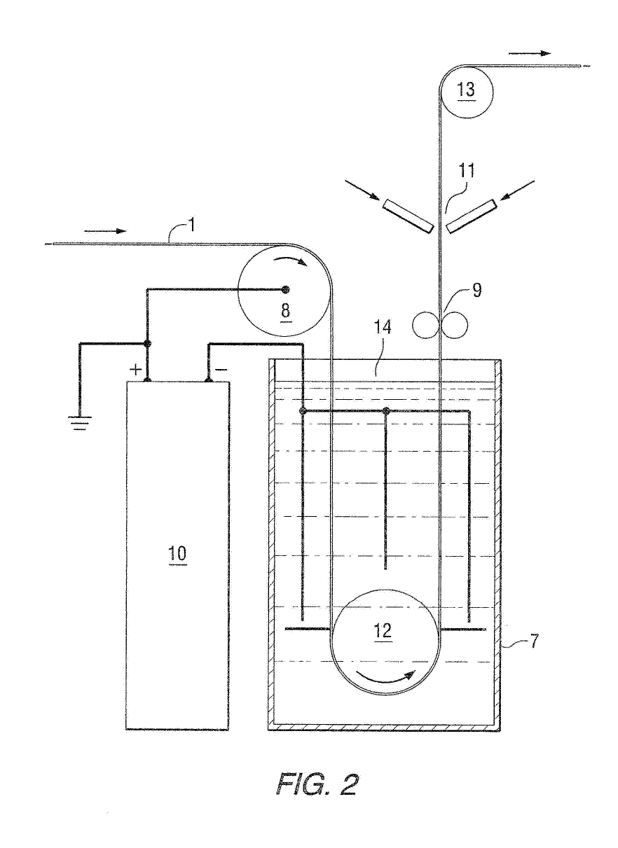

The method of the invention can be seen in connection with the attached drawings. Regarding FIG. 1, a continuous length of coiled metal sheet stock 1 is unwound from the spool 3 and optionally subjected to a cleaning and surface pretreatment. For example, the coil can be conveyed over a guide roll 4 to a tank 5 for degreasing with an alkali wash or the like. The sheet 1 can then be passed to a pretreatment tank 6 for corrosion pretreatment. After the optional pretreatments, the sheet is then passed to an electrodeposition tank 7 shown in more detail in FIG. 2, which contains the electrocoating vehicle of the invention. The sheet then passes through the electrodeposition bath where it is electrocoated with the resinous vehicle to form a coating. The coated sheet is passed over a change in direction roll 12; removed from the bath and passed between squeegee rolls 9 which return excess coating vehicle (dragout) to the electrodeposition tank 7. Optionally, the coated sheet is passed under an air knife 11 which removes any residual water and coating composition not removed by the squeegee rolls 9. The sheet to which the coating has been applied is then passed to a drying oven 15 wherein the coating is cured. The coated sheet is then cooled at either ambient conditions or optionally by passing the sheet through a chiller 17, and is then accumulated on a spool 19.

The metal that is coated in the process of the invention can be any electroconductive metal such as aluminum or steel and tin plated steel. The coil metal comes in a continuous length which is usually coiled on a spool. Generally, the gauge or thickness of the metal sheet is thin, being about 17 to 35 mils. The width of the sheet can vary depending on the application desired. Widths from as low as 9 to as high as 66 inches are not unusual.

Referring once again to the drawings, the electrodeposition bath into which the metal sheet is passed can be seen in some detail in FIG. 2. The sheet 1 passes over a guide roll 8 which is charged with either a positive or negative charge through rectifier 10. The electrodeposition tank 7 is grounded and contains electrodes charged in an opposite manner to that of the sheet such that when the sheet passes through the tank, an electrical potential will be established driving the resinous coating vehicle to the sheet 1 where it electrodeposits. Coating can be on one or both sides of the sheet depending on the electrode arrangement in the tank.

Variables such as distance of the metal sheet from the electrodes, residence time of the sheet in the bath and thickness of the applied coating are dependent not only on one another but also on the geometry of the electrodeposition tank and on the characteristics of the bath such as the electrocoating voltage, current draw, conductivity of the electrodeposition bath and resin solids content. In general, for efficient electrocoating, the sheet should pass no more than about 12 inches from the electrode and the sheet usually passes from about 2 to 4 inches from the electrode. Although the speed of the sheet passing through the electrodeposition bath is important for production considerations, the residence time of the sheet in the bath is perhaps a more important variable for electrocoating considerations. In general, line speeds of about 100 to 400 feet per minute are attainable with sheet widths of about 9 to 66 inches. Residence or electrodeposition times in the bath of from about 2 to 10 seconds at bath conductivities, voltages and current draws described below are typical.

In general, the resinous vehicle should be formulated so as to give an operating bath conductivity within the range of 200 to 3000 micromhos, preferably within the range of 1100 to 1800 micromhos. At these bath conductivities and at normal sheet line speeds and residence times in the electrodeposition bath, electrocoating is usually accomplished at 25 to 200 volts with an electrical current draw of 2 to 10 amps per square foot of (substrate) surface area per mil (coating) thickness.

The thickness of the coating is a function of the conductivity of the electrocoating vehicle as well as the voltage and current draw. In general, bath variables should be adjusted so as to produce a coating thickness on the order of about 0.01 to 1.0, preferably 0.1 to 0.5 mil that is the desirable thickness for can coatings.

The electrodeposition baths generally operate at 65° to 90° F. (18° to 32° C.).

Because of electroosmosis (flow of water out of the coating because of the coulomb force induced by the electric field during the electrodeposition process), the coating is non-tacky to the touch. This is referred to as good “green strength”. This enables the uncured coating to pass easily and not stick to the transfer rolls while passing from the coating station. In the coil electrocoating operations, the electrodeposition tank may be located a significant distance from the curing oven. The metal coil strip with the uncured coating may have to pass over numerous transfer and change of direction rolls in getting to the oven. Therefore, good green strength is important.

Although not shown in the drawings, it should be appreciated that the electrodeposition bath should be replenished with the coating composition to compensate for that which is removed from the bath as the coating. Replenishing the bath in a continuous manner with coating composition is well known in the art and further explanation at this point is not considered necessary.

The electrocoating vehicle is a salt of a poly(urethane-carbonate). The poly(urethane-carbonate) is obtained by reacting a polyisocyanate with a polycarbonate polyol such as a polycarbonate diol.

The polycarbonate polyol can be a polycarbonate diol of a 2-alkyl-1,3-propanediol, a 2,2-dialkyl-1,3-propanediol, an alkoxylated 2-alkyl-1,3-propanediol, an alkoxylated 2,2-dialkyl-1,3-propanediol and/or a polycarbonate diol comprising units from two or more said 1,3-propanediols. Alkyl in said 1,3-propanediols is preferably linear or branched saturated aliphatic alkanyl having 1-8 carbon atoms and alkoxylated is likewise preferably ethoxylated, propoxylated and/or butoxylated having 1-20 alkoxy units.

The polycarbonate diol is typically at least one polycarbonate diol of 2-methyl-1,3-propanediol, 2-methyl-2-ethyl-1,3-propanediol, 2-ethyl-2-butyl-1,3-propanediol, 2,2-dimethyl-1,3-propanediol and/or is at least one polycarbonate diol comprising units from two or more said 1,3-propanediols. Said polycarbonate diol has in preferred embodiments a number average molecular weight of 500-5000, such as 500-2500, and can suitably be obtained from for example one or more of the 1,3-propanediols and a carbon dioxide source, such as dimethyl carbonate, diethyl carbonate and/or urea. Such polycarbonate polyols are available from Perstop Holdings under the trademarks Oxymer C and Oxymer M.

The poly(urethane-carbonate) can be prepared by first forming an isocyanate functional prepolymer and chain extending the prepolymer in aqueous medium with a chain extender.

Typically, the prepolymer is the reaction product of at least one polyisocyanate, at least one polycarbonate polyol, at least one isocyanate reactive compound comprising one or more ionic groups or potential ionic groups per molecule.

As used herein, the term “dispersion” refers to a system in which the dispersed phase consists of finely divided particles dispersed in a continuous aqueous phase.

As used herein, the term “aqueous poly(urethane-carbonate) dispersion” refers to a composition containing the salt of the poly(urethane-carbonate) or the precursor prepolymer that has been dispersed in an aqueous medium.

The aqueous poly(urethane-carbonate) dispersion is typically made in two stages: the first being the formation of the prepolymer and the second stage being the formation of the dispersion. The prepolymer is the reaction product of: (a) at least one polyisocyanate which may comprise aliphatic, cycloaliphatic or aromatic polyisocyanate, (b) at least one polycarbonate polyol, and (c) at least one isocyanate-reactive compound which comprises an ionic group or a potential ionic group per molecule, such as a carboxylic acid functional group capable of forming a salt upon neutralization. The isocyanate-reactive compound has at least two isocyanate-reactive groups per molecule selected from a hydroxyl, a primary amino, a secondary amino or thio, and combinations thereof.

The reaction occurs using a stoichiometric excess of the polyisocyanate component (a) described above relative to the sum of the polycarbonate polyol (b) and the isocyanate-reactive compound (c) to produce an oligomer that typically contains urethane, urea and/or thio urethane and carbonate groups. The amount of the polyisocyanates may range from about 5 percent to about 45 percent, such as 15 percent to 35 percent by weight of the reaction mixture based on resin solids.

The polyisocyanates can be selected from the group consisting of linear aliphatic, cycloaliphatic, aromatic and mixtures thereof. Exemplary diisocyanate compounds include but are not limited to, tetramethylxylene diisocyanate (TMXDI); 1-isocyanato-3-isocyanatomethy-3; 5,5-trimethyl-cyclohexane (isophorone diisocyanate (IPDI)) and derivatives thereof; tetramethylene diisocyanate; hexamethylene diisocyanate (HDI) and derivatives thereof; 2,4-toluene diisocyanate (2,4-TDI); 2,6-toluene diisocyanate (2,6-TDI); m-isopropenyl-alpha, alpha-dimethylbenzyl isocyanate and 4,4′-dicyclohexylmethane diisocyanate. The polyisocyanates listed above may be used individually or in admixture.

As mentioned above, the isocyanate-terminated prepolymer is prepared using at least one polycarbonate polyol. The term “polyol” as used herein refers to any organic compound having 2 or more hydroxyl groups that are capable of reacting with an isocyanate group. The amount of the polycarbonate polyol within the isocyanate-terminated prepolymer reaction mixture may range from about 10 percent to about 90 percent, such as about 30 percent to about 70 percent by weight of the prepolymer reaction mixture based on resin solids.

Besides the polycarbonate polyol, other polyols optionally may be used with the polycarbonate polyol. These other or optional polyols may be low molecular weight polyols having number average molecular weights of 60 to 500, such as 90 to 300. Examples include the difunctional alcohols known from polyurethane chemistry, such as ethanediol; 1,2- and 1,3-propanediol; 1,2-, 1,3- and 1,4-butanediol; 1,5-pentanediol; 1,6-hexanediol; neopentyl glycol; cyclohexane-1,4-dimethanol; 1,2- and 1,4-cyclohexanediol; 2-ethyl-2-butylpropanediol; diols containing ether oxygen (such as diethylene glycol, triethylene glycol, tetraethylene glycol, dipropylene glycol, tripropylene glycol, polyethylene, polypropylene or polybutylene glycols), and mixtures thereof.

Besides low molecular weight polyols, polymeric polyols such as polyester polyols and polyether polyols may optionally be used. Examples of polyester polyols are those produced by condensation polymerization of polycarboxylic acids or their ester-forming derivatives, and polyols, typically low molecular weight polyols with no more than 12 carbon atoms in each molecule. Examples of suitable polycarboxylic acids and their ester-forming derivatives are malonic acid, succinic acid, glutaric acid, adipic acid and their methyl esters, pimelic acid, suberic acid, azelaic acid, sebacic acid, undecanedicarboxylic acid and dodecanedicarboxylic acid, phthalic anhydride and dimethyl terephthalate. Examples of suitable polyols for preparing the polyester polyols are ethylene glycol, propanediol, 1,4-butanediol, diethylene glycol, trimethylolpropane, and pentaerythritol, including mixtures thereof. Polyesters obtained by the polymerization of lactones, for example caprolactone, in conjunction with a polyol may also be used as the polyol.

Polyether polyols suitable for preparation of isocyanate-terminated prepolymer include products obtained by the polymerization of a cyclic oxide, for example, ethylene oxide, propylene oxide, trimethylene oxide and tetrahydrofuran, or by the addition of one or more such oxides to polyfunctional initiators, for example, ethylene glycol, propylene glycol and diethylene glycol. Specific examples of polyethers include polyoxypropylene diols and triols, poly(oxyethylene-oxypropylene) diols and triols obtained by the simultaneous or sequential addition of ethylene oxide and propylene oxide to appropriate initiators and polytetramethylene ether glycols obtained by the polymerization of tetrahydrofuran.

When used, the optional polyols are present in amounts of up to 20, such as up to 10 percent by weight of the prepolymer reaction mixture based on weight of resin solids.

The isocyanate-reactive compound (c) comprising an ionic group or a potential ionic group per molecule contains at least two isocyanate-reactive groups per molecule. The isocyanate-reactive groups may comprise hydroxyl group, thio group, primary amino group, a secondary amino group, and combinations thereof. The potential ionic groups are groups that can be converted to ionic groups upon neutralizing with a neutralizing agent. By neutralizing is also meant partial neutralization. The ionic groups can be formed by neutralizing the corresponding potential ionic groups with a neutralizing agent. The ionic or potential ionic groups include either cationic or anionic groups. Examples of anionic groups include carboxylate, phosphate and sulfonate, and examples of cationic groups are amine salt groups and quaternary ammonium groups. Within the context of this invention, the term “neutralizing agents” is meant to embrace all types of agents which are useful for converting potential ionic groups to ionic groups. Accordingly, this term also embraces quaternizing agents and alkylating agents.

The anionic groups may be carboxylate or sulfonate groups. The carboxylate and sulfonate groups may be introduced into the prepolymer by reacting hydroxyl-containing carboxylic or hydroxyl-containing sulfonic acids with the polyisocyanate, and neutralizing the acid groups with a neutralizing agent. Examples of hydroxyl-containing carboxylic acids and hydroxyl-containing sulfonic acids are represented by the following general formulas:

(HO)ₓ-Q-(COOH)_{y}

(HO)ₓ-Q-(SO₃H)_{y}

wherein Q represents an organic radical containing 1 to 12 carbon atoms, and x and y represent an integer of from 1 to 3.

Specific examples of these hydroxyl-containing carboxylic acids or hydroxyl-containing sulfonic acids are dimethylolpropionic acid and dimethylolpropyl sulfonic acid. The isocyanate-reactive compound (c) is present within the reaction mixture from about 1 percent to about 10 percent, such as 2 to 8 percent by weight of the prepolymer reaction mixture based on weight of resin solids.

The previously described neutralizing agents are used to convert the potential ionic groups to ionic groups. Suitable neutralizing agents for neutralizing acid groups such as carboxylic acid and sulfonic acid groups include inorganic alkali metal bases such as potassium hydroxide, sodium hydroxide, and lithium hydroxide, ammonia, primary, secondary or tertiary amines, such as trimethyl amine, triethyl amine, triisopropyl amine; tributyl amine; N,N-dimethyl-cyclohexyl amine; N,N-dimethylstearyl amine; N,N-dimethylaniline; N-methylmorpholine; N-ethylmorpholine; N-methylpiperazine; N-methylpiperidine; 2-methoxyethyldimethyl amine; triethylamine, tributyl amine, N-methylmorpholine, N,N-dimethyl-ethanolamine and N,N-diethyl ethanolamine. Suitable neutralizing agents for neutralizing basic groups such as amino groups are organic acids such as acetic and lactic acid.

When the potential ionic groups of the prepolymer are neutralized, they provide hydrophilicity to the prepolymer and enable it to be stably dispersed in water and to provide sufficient ionic character for electrodeposition. Accordingly, it may be desirable that a sufficient amount of the potential ionic groups be neutralized so that the final product will be a stable, aqueous dispersion. When relatively large amounts of potential ionic groups are incorporated into the prepolymer, only a portion of these groups may need to be neutralized to provide the necessary amount of hydrophilicity and ionic character for electrodeposition. However, when small amounts of potential ionic groups are incorporated, it may be necessary to neutralize substantially all of these groups to obtain the desired amount of hydrophilicity and ionic character. In the present invention, the amount of neutralizing agent that is added is sufficient to react about 40 to 120 molar percent, such as 50 to 100 molar percent, of the potential ionic groups contained within the isocyanate-reactive compound.

The neutralization steps may be conducted by the following 4-step process: (1) prior to prepolymer formation by treating the component containing the potential ionic group(s), (2) after prepolymer formation, but prior to dispersing the prepolymer in water, (3) by adding the neutralizing agent to all or a portion of the dispersing water, or (4) a combination of (2) and (3) above.

As mentioned above, the isocyanate-terminated prepolymer is the reaction product of a polyisocyanate, a polycarbonate polyol, a compound containing isocyanate-reactive groups, and a compound containing potential ionic groups. The ratio of isocyanate groups to isocyanate-reactive groups is maintained between about 1.1 to 4.0, such as 1.1 to 2.0 on an equivalent basis in the reaction mixture. The above components may be reacted simultaneously or sequentially to produce the isocyanate-terminated prepolymer.

The isocyanate-terminated prepolymer is typically prepared in a suitable reactor wherein the reactants are suitably combined, mixed, and reacted, and wherein heat may be transferred in to, and away from, the reactor. The synthesis of the isocyanate-terminated prepolymer may be conducted in an atmosphere that minimizes or eliminates the introduction of water into the reaction mixture such as a nitrogen and/or inert atmosphere. The reactants may be added slowly as in a semi-batch process over time, continuously, or quickly as a batch-wise process into the reactor. Typically, the reactants are gradually added to the reactor. The reactants may be added in any particular order.

The reaction temperature during prepolymer production is normally maintained below about 150° C., such as 50 to 120° C. The reaction is maintained at the temperature until the amount of unreacted isocyanate-reactive groups is constant.

Optionally, the reaction mixture may further comprise a catalyst to shorten the overall reaction time. In general, the amount of the catalyst present during the reaction may range from about 0.02% to about 0.08%, such as 0.05 to 0.06% by weight resin solids of the reaction mixture. Suitable catalysts include amines such as trialkyl amines for example triethylamine and tin based materials such as dibutyltin dilaurate.

After the isocyanate-terminated prepolymer is prepared, the prepolymer is then dispersed in water. In the present invention, the prepolymer may be added to the water or water-neutralizing agent mixture. The prepolymer is usually added in increments. The aqueous mixture may be agitated during the addition of the prepolymer to assist in forming the dispersion.

After and/or during the dispersing step, one or more chain extending agents (also referred to as chain extenders) are added and allowed to react with isocyanate terminated prepolymer to provide the aqueous polyurethane dispersion. Upon reaction between the prepolymer and the chain extending agents, the polyurethane polymer and the polyurethane dispersion is created.

Chain extending agents contain at least two isocyanate reactive functional groups that are capable of reacting with isocyanate groups in prepolymer. They may contain reactive hydrogen atoms such as hydroxyl, thio, or amino groups in any combination. The exemplary chain extending agents include the following: polyols such as ethylene glycol, butane-1,3-diol, butane-1,4-diol, butenediol, propane-1,2-diol, propane-1,3-diol, neopentyl glycol, hexanediol and bis-hydroxymethyl cyclohexane, aliphatic, cycloaliphatic and aromatic diamines, such as 1,2-ethylenediamine, 1,4-butanediamine, hexamethylenediamine, 1,4-bis(aminomethyl)cyclohexane, 4,4′-methylene-bis(cyclohexylamine), 2,2-dimethyl-1,3-propanediamine, 1,2-propanediamine, 1,2-cyclohexanediamine, isophorone diamine, N-methyl propylenediamine and diethylene triamine. Other diamines such as hydrazine, diaminodiphenyl methane or the isomers of phenylenediamine may be used. Also carbohydrazides or hydrazides of dicarboxylic acids can be used as chain extending agents.

The total amount of chain extending agents to be used in accordance with the present invention is dependent upon the number of terminal isocyanate groups in the prepolymer. Generally, the ratio of terminal isocyanate groups of the prepolymer to the active hydrogens of the chain extending agent is between from about 1.0:0.5 to 1.0:1.2, such as 1.0:0.6 to 1.0:1.1. Lesser amounts of difunctional/polyfunctional amine will allow for reaction of the isocyanate groups with water, while an undue excess may lead to products with lower molecular weights than desired. For the purposes of these ratios, a primary amino group is considered to have one amino hydrogen. For example, ethylene diamine has two equivalents of amino hydrogens and diethylene triamine has three equivalents.

The chain extension reaction between the dispersed prepolymer and the chain extending agents is conducted at temperatures from about 20 to 90° C., such as 50 to 80° C. The reaction conditions are normally maintained until the isocyanate groups are substantially completely reacted.

The polyurethane dispersion is a stable, aqueous dispersion of colloidal-sized particles of poly(urethane-carbonate) polymer. The term colloidal size refers to molecules or polymolecular particles dispersed in a medium wherein the majority (or greater than 80% or greater than 90% of the particles) have at least in one direction a dimension roughly between 20 nanometer(s) and 140 micron(s), such as about 50 nanometers to about 110 micron(s). The small particle size enhances the stability of the dispersed particles.

The aqueous polyurethane dispersions disclosed herein may comprise water and from about 5 to about 50 weight percent, typically from about 10 to 40, percent by weight poly(urethane-carbonate) based on total weight of the aqueous polyurethane dispersion.

The polyurethane polymer contained within the aqueous polyurethane dispersion has a theoretical free isocyanate functionality of approximately zero, and a number average molecular weight of at least 15,000, such as from 15,000 to 250,000, such as 20,000 to 100,000.

Usually, polyfunctional crosslinking agents can be added to the poly(urethane-carbonate) dispersions. Crosslinking agents can be selected from the group consisting of aminoplast, aziridines, epoxies, carbodiim ides and mixtures thereof. The crosslinking agents are present in a range from about 0.1 percent by weight to about 20 percent by weight, such as from 0.3 percent by weight to about 10 percent by weight, based on resin solids weight of the poly(urethane-carbonate) and the crosslinking agent.

Aminoplast resins are the condensation products of aldehydes such as formaldehyde, acetaldehyde, crotonaldehyde, and benzaldehyde with amino or amido group-containing substances such as urea, melamine, and benzoguanamine.

Examples of suitable crosslinking resins include, without limitation, benzoguanamine-formaldehyde resins, melamine-formaldehyde resins, esterified melamine-formaldehyde, and urea-formaldehyde resins. Preferably, the crosslinker employed when practicing this invention includes a melamine-formaldehyde or benzoguanamine-formaldehyde resin. One specific example of a particularly useful crosslinker is a melamine-modified benzoguanamine-formaldehyde resin commercially available from Ineos, Inc. as Maprenal MF.

The aqueous dispersions (coating compositions) used in the practice of the present invention may also include other optional ingredients that do not adversely affect the coating composition or a cured coating composition resulting therefrom. Such optional ingredients are typically included in a coating composition to enhance composition esthetics, to facilitate manufacturing, processing, handling, and application of the composition, and to further improve a particular functional property of a coating composition or a cured coating composition resulting therefrom.

Such optional ingredients include, for example, curing catalysts, dyes, pigments, toners, extenders, fillers, lubricants, anticorrosion agents, flow control agents, thixotropic agents, dispersing agents, antioxidants, adhesion promoters, light stabilizers, surfactants, and mixtures thereof. Each optional ingredient is included in a sufficient amount to serve its intended purpose, but not in such an amount to adversely affect electrodeposition of the coating composition or a cured coating composition resulting therefrom.

Another useful optional ingredient is a pigment, such as titanium dioxide. If used, a pigment is present in the coating composition in an amount of no greater than 70 weight percent, more preferably no greater than 50 weight percent, and even more preferably no greater than 40 weight percent, based on the total weight of solids in the coating composition.

In certain embodiments, the compositions used in the practice of the invention are substantially free, may be essentially free and may be completely free of bisphenol A and derivatives or residues thereof, including bisphenol A (“BPA”) and bisphenol A diglycidyl ether (“BADGE”). Such compositions are sometimes referred to as “BPA non intent” because BPA, including derivatives or residues thereof, are not intentionally added but may be present in trace amounts because of unavoidable contamination from the environment. The compositions can also be substantially free and may be essentially free and may be completely free of bisphenol F and derivatives or residues thereof, including bisphenol F and bisphenol F diglycidyl ether (“BPFG”). The term “substantially free” as used in this context means the compositions contain less than 1000 parts per million (ppm), “essentially free” means less than 100 ppm and “completely free” means less than 20 parts per billion (ppb) of any of the above-mentioned compounds, derivatives or residues thereof.

The coating compositions used in the practice of the present invention are particularly well adapted for use on food and beverage cans (e.g., two-piece cans, three-piece cans, etc.). Two-piece cans are manufactured by joining a can body (typically a drawn metal body) with a can end (typically a stamped metal end). The coatings of the present invention are suitable for use in food or beverage contact situations and may be used on the inside of such cans. They are suitable for the interior of two-piece draw/redraw drawn and ironed beverage cans and for beverage can ends. To form the can, the coated metal sheet stock is taken from the point of accumulation, cut into metal blanks and the blanks formed into a food or beverage can or portion thereof, such as by stamping out can ends or by drawing can bodies.

As used herein, unless otherwise expressly specified, all numbers such as those expressing values, ranges, amounts or percentages may be read as if prefaced by the word “about”, even if the term does not expressly appear. Any numerical range recited herein is intended to include all sub-ranges subsumed therein. Plural encompasses singular and vice versa. As used herein, the term “polymer” is meant to refer to prepolymers, oligomers and both homopolymers and copolymers; the prefix “poly” refers to two or more. When ranges are given, any endpoints of those ranges and/or numbers within those ranges can be combined with the scope of the present invention. “Including”, “such as”, “for example” and like terms means “including/such as/for example but not limited to”. As used herein, the molecular weights are on a number average basis unless indicated otherwise as determined by gel permeation chromatography using a polystyrene standard. Food or foods include solid foodstuffs and liquid foodstuffs such as beverages.

### EXAMPLES

The following examples are offered to aid in understanding of the present invention and are not to be construed as limiting the scope thereof. Unless otherwise indicated, all parts and percentages are by weight.

### Example 1

A three-liter round bottom, four-necked flask equipped with an agitator, a nitrogen inlet tube, a thermometer, and a reflux condenser was charged with 500 parts of an aliphatic polycarbonate diol and 46.85 parts of dimethyl propionic acid. The aliphatic polycarbonate diol was available from Perstop as Oxymer C112 and had a hydroxyl number of 117. The flask was heated gradually to 60° C. At 60° C., 301.28 parts of dipropylene glycol dimethyl ether and 1.19 parts of triethylamine were charged in order. The flask was heated to 80° C. Once the temperature reached 80° C., 237.05 parts of isophorone diisocyanate was added over 1 hour through an addition funnel while maintaining the temperature at 80° C. The addition funnel was then rinsed with 75.32 parts of dipropylene glycol dimethyl ether. The batch was then held at 80° C. for 3 hours. During the hold, in a separate vessel, a chain extender solution of 1575.49 parts of deionized water, 21.02 parts of isophorone diamine, 30.70 parts of diethyl ethanolamine, and 3.48 parts of DEE FO 300F defoamer from Munzing was prepared, and the mixture was heated to 50° C. At the end of the 3-hour hold, the isocyanate equivalent weight of the NCO-prepolymer was above 2963.8 and the prepolymer was added to the chain extender solution over 20 minutes. Heat was turned off and the temperature went up with the addition of the NCO-prepolymer. After chain extension, 41.84 parts of 2-ethylhexanol, 13.44 parts of dodecyl benzene sulfonic acid solution available from King Industries as Nacure 5925, and 191.65 parts of Maprenal MF 986/80B aminoplast crosslinker, available from Ineos, were added in order. When the temperature dropped down to 48° C., 4.79 parts of PTFE (polytetrafluoroethylene) dispersion available from Micro Powders as Microspersion HT and 19.88 parts of an anionic paraffin/carnauba wax available from Michelman as Michem Lube 388F were added. Finally, 170.41 parts of deionized water was added as a rinse. This batch yielded a polymer dispersion with 28.33% NV, a particle size of 0.073±0.016 μm, a viscosity of 178 centipoise, and a number average molecular weight of 23,712.

The ingredients listed below were thoroughly mixed to produce an electrocoating composition having a solids content of 11%. This coating composition was ultrafiltered and then neutralized to 100% with N,N-diethyl ethanolamine.

| Ingredient | Parts by Weight |
|---|---|
| Polycarbonate dispersion | 1447.41 |
| Deionized water | 2152.59 |

The electrocoating composition was used to coat aluminum panels by anodic electrodeposition. Panels were coated at 1.70 to 2.2 milligrams per square inch. The coated panels were then baked in a simulated coil oven for a total of 12 seconds, with an air temperature sufficient to reach a peak metal temperature of 450° F. (232° C.) for approximately 2 seconds. The application parameters and resulting information is listed below:

| | | | | Film Weight |
|---|---|---|---|---|
| Run Number | Voltage | Amperage | Coulombs | (Mgs/Sq. Inch) |
| 1 | 25 | 4.5 | 7.6 | 1.88 |
| 2 | 27 | 4.5 | 7.6 | 1.70 |
| 3 | 30 | 5.4 | 8.7 | 1.88 |
| 4 | 55 | 11.7 | 10.8 | 2.15 |

The properties of the cured coating are listed below:

| Dry Film Test | Test Results |
|---|---|
| Joy Detergent Test | |
| Blush | 8 |
| Adhesion | No loss |
| Dowfax Detergent Test | |
| Blush | 8 |
| Adhesion | No loss |
| Water Pasteurization Test | |
| Blush | 9 |
| Adhesion | No loss |
| Coefficient of Friction Test | 0.060 |
| Easy Open End Fabrication | 35.5 milliamps |

### Resistance Testing

Blush resistance measures a film's resistance to the absorption of the test solution. When a film absorbs the test solution, the film becomes more opaque and less gloss is normally seen; at its worse, the film can appear white. The blush resistance rating is normally expressed in terms of 0-10, with 0 being a totally opaque and white appearing film and 10 being no blush at all.

### Joy Detergent Testing

The Joy Test is performed by making a 1° A solution of Joy Detergent (commercially available from The Proctor & Gamble Corporation) in deionized water. The solution is heated to and held at 180° F. (82° C.). Part of a coated panel is immersed in the test solution such that part of the panel is immersed and the remainder of the panel is held in place above the surface of the test solution. The panel is immersed in the solution for 10 minutes and then it is immediately tested for adhesion and blush resistance, as explained above.

### Dowfax Detergent Testing

The Dowfax Test is performed by making a solution of 1 ml of Dowfax A21 (commercially available from The Dow Chemical Corporation) in 600 ml of deionized water. The solution is heated to and held at boil. Part of a coated panel is immersed in the test solution such that part of the panel is immersed and the remainder of the panel is held in place above the surface of the test solution. The panel is immersed in the solution for 15 minutes and then it is immediately tested for adhesion and blush resistance, as explained above.

### Water Pasteurization Testing

The Water Pasteurization Test is performed by heating deionized water to 180° F. (82° C.). Part of a coated panel is immersed in the water such that part of the panel is immersed and the remainder of the panel is held in place above the surface of the water. The panel is immersed in the water for 45 minutes and then it is immediately tested for adhesion and blush resistance, as explained above.

### Coefficient of Friction

Coefficient of friction is a measurement of the lubricity of a surface and in this particular work, it is measured by an Altek Mobility Tester (commercially available from The Paul N. Gardner Company). The preferred results for a commercially viable coating are in the range of 0.050-0.060.

### Easy Open End Fabrication

This test determines the ability of a coating to withstand the high speed fabrication of a flat piece of metal into a beverage can end. We assess this ability of the coating by determining to what extent the fabricated metal and therefore deformed coating has withstood the deformation without exhibiting cracking or other film defects. The deformed film is exposed to an electrolyte solution and the amount of current that passes through the film is measured. A perfectly formed film without cracking or defects would exhibit a measured current of 0 milliamps passing through the film. This conductance of the film can be measured with a WACO Enamel Rater (commercially available from Wilkens-Anderson). A commercially viable beverage coating should have conductance of less than 50 milliamps and more preferably less than 40 milliamps.

### Example 2

A three-liter round bottom, four-necked flask equipped with an agitator, a nitrogen inlet tube, a thermometer, and a reflux condenser was charged with 400 parts of the polycarbonate diol used in Example 1 and 72.74 parts of dimethyl propionic acid. The flask was heated gradually to 60° C. At 60° C., 287.83 parts of isophorone diisocyanate was charged over 10 minutes followed with the addition of 325.96 parts of dipropylene glycol dimethyl ether as rinse. Then 1.44 parts of triethylamine was added as catalyst. Once the catalyst had been added, exotherm took place and brought the reaction temperature to ˜65° C. The flask was then heated to 80° C. and held at 80° C. for about 3 hours until the NCO equivalent weight of the NCO-prepolymer reached the target value of 1620.1. During the hold, in a separate vessel, a chain extender solution of 1000 parts of deionized water, 31.51 parts of isophorone diamine, and 47.66 parts of diethyl ethanolamine was prepared, heated to 50° C. and added to the NCO-prepolymer over 20 minutes. Afterwards, 387.95 parts of water were added as rinse. This batch yielded a polymer dispersion with 31.16% NV, a viscosity of 4,696 centipoise, and a number average molecular weight of 7,574.

The ingredients listed below were thoroughly mixed to produce an electrocoating composition having a solids content of 10.5%. This coating composition was ultrafiltered and the electrocoating composition was then neutralized to 100% with N,N-diethyl ethanolamine. The composition was used to coat aluminum panels by anodic electrodeposition. Panels were coated at 2.0 milligrams per square inch. The coated panels were then baked in a simulated coil oven for a total of 12 seconds, with an air temperature sufficient to reach a peak metal temperature of 450° F. (232° C.) for approximately 2 seconds.

The electrocoating composition made from the above-described polycarbonate dispersion was prepared as follows:

| Ingredient | Parts by Weight |
|---|---|
| Polycarbonate dispersion | 910.93 |
| Microdispersion 215-50 lubricant | 3.93 |
| Michem Lube 388F | 13.70 |
| Deionized water | 2171.75 |
| Propylene glycol monomethyl ether | 18.22 |
| Texanol | 22.77 |
| Maprenal MF986 | 57.76 |
| Dodecyl benzene sulfonic acid | 0.83 |

The electrocoating composition was used to coat aluminum panels by anodic electrodeposition. Panels were coated at 1.6 to 1.9 milligrams per square inch. The coated panels were then baked in a simulated coil oven for a total of 12 seconds, with an air temperature sufficient to reach a peak metal temperature of 450° F. (232° C.) for approximately 2 seconds. The application parameters and resulting information is listed below:

| | | | | Film Weight |
|---|---|---|---|---|
| Run Number | Voltage | Amperage | Coulombs | (Mgs/Sq. Inch) |
| 1 | 50 | 2.7 | 5.5 | 1.60 |
| 2 | 60 | 3.2 | 5.9 | 1.90 |
| 3 | 60 | 3.3 | 6.1 | 1.90 |
| 4 | 60 | 3.4 | 6.0 | 1.90 |
| 5 | 60 | 3.3 | 5.8 | 1.90 |
| 6 | 60 | 3.2 | 5.9 | 1.90 |

The properties of the cured coating are listed below:

| Dry Film Test | Test Results |
|---|---|
| Joy Detergent Test | |
| Blush | 7 |
| Adhesion | No loss |
| Dowfax Detergent Test | |
| Blush | 6 |
| Adhesion | No loss |
| Water Pasteurization Test | |
| Blush | 8 |
| Adhesion | No loss |
| Coefficient of Friction Test | 0.050 |
| Easy Open End Fabrication | 30.2 milliamps |

### Example 3

### Adipic Acid Dihydrazide as Chain Extender Instead of Isophorone Diamine

A three-liter round bottom, four-necked flask equipped with an agitator, a nitrogen inlet tube, a thermometer, and a reflux condenser was charged with 600 parts of the polycarbonate diol used in Example 1 and 56.22 parts of dimethyl propionic acid. The flask was heated gradually to 60° C. At 60° C., 284.46 parts of isophorone diisocyanate was charged over 10 minutes followed with the addition of 233.75 parts of dipropylene glycol dimethyl ether as rinse. Then 1.42 parts of triethylamine was added as catalyst. Once the catalyst had been added, exotherm took place and brought the reaction temperature to ˜72° C. The flask was then heated to 80° C. and held at 80° C. for about 3 hours until the NCO equivalent weight of the NCO-prepolymer reached the target value of 2500. During the hold, in a separate vessel, a chain extender solution of 1511.82 parts of deionized water, 22.76 parts of adipic acid dihydrazide, and 36.84 parts of diethyl ethanolamine was prepared, heated to 50° C. and added to the NCO-prepolymer over 20 minutes. Afterwards, 86.41 parts of water were added as rinse. This batch yielded a polymer dispersion with 33.96% NV, a particle size of 0.123±0.055 μm, a viscosity of 3,712 centipoise, and a number average molecular weight of 36,085.

The ingredients listed below were thoroughly mixed to produce a coating composition having a solids content of 23.0%.

| Ingredient | Parts by Weight |
|---|---|
| Polycarbonate dispersion | 35.21 |
| Deionized water | 10.93 |
| Microdispersion HT | 0.16 |
| Michem Lube 388F | 0.28 |
| Deionized water | 10.93 |
| 2-Ethyl hexanol | 0.58 |
| Maprenal MF986 | 0.00 |
| Cymel 303 | 1.91 |
| Dodecyl benzene sulfonic acid | 0.00 |

The coating composition was applied to 5×15 inch aluminum panels using wire wound application rods that produced dry coated films of 2.0 milligrams per square inch. The coated panels were then baked in a simulated coil oven for a total of 12 seconds, with an air temperature sufficient to reach a peak metal temperature of 450° F. (232° C.) for approximately 2 seconds.

The properties of the cured coating are listed below:

| Dry Film Test | Test Results |
|---|---|
| Joy Detergent Test | |
| Blush | 7 |
| Adhesion | No loss |
| Dowfax Detergent Test | |
| Blush | 5 |
| Adhesion | No loss |
| Water Pasteurization Test | |
| Blush | 7 |
| Adhesion | No loss |
| Coefficient of Friction Test | 0.055 |
| Easy Open End Fabrication | 38.7 milliamps |

### Example 4

### 1,6-Hexanediamine as Chain Extender Instead of Isophorone Diamine

A five-liter round bottom, four-necked flask equipped with an agitator, a nitrogen inlet tube, a thermometer, and a reflux condenser was charged with 600 parts of the polycarbonate diol used in Example 1 and 56.22 parts of dimethyl propionic acid. The flask was heated gradually to 60° C. At 60° C., 361.53 parts of dipropylene glycol dimethyl ether and 1.42 parts of triethylamine was charged over 5 minutes and then the batch was heated to 80° C. When batch temperature reached 80° C., 284.46 parts of isophorone diisocyanate was charged over 1 hour while the batch temperature was maintained at 80° C., followed with the addition of 90.38 parts of dipropylene glycol dimethyl ether as rinse. The batch was held at 80° C. for another 3 hours until the NCO equivalent weight of the NCO-prepolymer reached the target value of 2963.8. Once reached target NCO equivalent weight, heat was turned off and batch was let to cool down to 50° C. During cool down, in a separate vessel, a chain extender solution of 1893.88 parts of deionized water, 34.43 parts of 1,6-hexanediamine, 36.84 parts of diethyl ethanolamine, and 4.22 parts of DEEFO 300F defoamer was prepared and heated to 50° C. When batch temperature dropped to 50° C., the chain extender solution was added into the reaction flask over 15 minutes. Then 50.21 parts of 2-ethylhexanol, 16.29 parts of Nacure 5925 curing catalyst, and 232.17 parts of Maprenal MF 986/80B crosslinker were added in order. Once batch temperature dropped below 40° C., 5.80 Microdispersion HT and 24.08 parts of Michem Lube 388F wax were added, followed by 1009.98 parts of deionized water as rinse. This batch yielded a polymer dispersion with 23.54% NV, a viscosity of 884 centipoise and a number average molecular weight of 18,500.

The ingredients listed below were thoroughly mixed to produce an electrocoating composition having a solids content of 11%. The electrocoating composition was ultrafiltered and then neutralized to 100% with N,N-diethyl ethanolamine.

| Ingredient | Parts by Weight |
|---|---|
| Polycarbonate dispersion | 1502.84 |
| Deionized water | 2362.16 |

The electrocoating composition was used to coat aluminum panels by anodic electrodeposition. Panels were coated at approximately 2.0 milligrams per square inch. The coated panels were then baked in a simulated coil oven for a total of 12 seconds, with an air temperature sufficient to reach a peak metal temperature of 450° F. (232° C.) for approximately 2 seconds. The application parameters and resulting information is listed below:

| | | | | Film Weight |
|---|---|---|---|---|
| Run Number | Voltage | Amperage | Coulombs | (Mgs/Sq. Inch) |
| 1 | 105 | 6.7 | 11.4 | 1.99 |
| 2 | 105 | 6.6 | 11.2 | 1.92 |
| 3 | 105 | 6.6 | 11.7 | 1.91 |
| 4 | 105 | 6.6 | 11.5 | 1.90 |
| 5 | 105 | 6.5 | 11.3 | 1.98 |
| 6 | 105 | 6.5 | 11.2 | 1.93 |
| 7 | 105 | 6.6 | 11.0 | 1.91 |
| 8 | 105 | 6.6 | 11.3 | 1.82 |

The properties of the cured coating are listed below:

| Dry Film Test | Test Results |
|---|---|
| Joy Detergent Test | |
| Blush | 4 |
| Adhesion | No loss |
| Dowfax Detergent Test | |
| Blush | 5 |
| Adhesion | No loss |
| Water Pasteurization Test | |
| Blush | 6 |
| Adhesion | No loss |
| Coefficient of Friction Test | 0.050 |
| Easy Open End Fabrication | 21.4 milliamps |

Whereas particular embodiments of this invention have been described above for purposes of illustration, it will be evident to those skilled in the art that numerous variations of the details of the present invention may be made without departing from the invention as defined in the appended claims.

Although various embodiments of the invention have been described in terms of “comprising”, embodiments consisting essentially of or consisting of are also within the scope of the present invention.

What is claimed is:

1. A method for electrocoating a continuous length of flat metal sheet comprising:
(a) withdrawing the flat metal sheet from a supply source and continuously
(b) passing the sheet into an aqueous electrodeposition bath that contains as an electrocoating vehicle a salt of a poly(urethane-carbonate),
(c) electrodepositing a coating of a poly(urethane-carbonate) as the sheet passes through the electrodeposition bath to form a coated sheet,
(d) passing the coated sheet through a curing station to form a cured coating,
(e) leading the sheet with the cured coating to a point of accumulation.

2. The method of claim 1 in which the flat metal sheet is aluminum or steel.

3. The method of claim 1 in which the poly(urethane-carbonate) is prepared by reacting a polyisocyanate with a polycarbonate polyol.

4. The method of claim 3 in which the polycarbonate polyol is a diol.

5. The method of claim 4 in which the polycarbonate diol has an Mn of 500-5000.

6. The method of claim 4 in which the polycarbonate diol is prepared from an alkyl-substituted or an alkoxy-substituted 1,3-propanediol and a carbon dioxide source.

7. The method of claim 4 in which the alkyl-substituted 1,3-propanediol is selected from the class consisting of 2-alkyl-1,3-propanediol and 2,2-dialkyl-1,3-propanediol.

8. The method of claim 7 in which the alkyl contains from 1 to 8 carbon atoms.

9. The method of claim 7 in which the alkyl is selected from ethyl and butyl.

10. The method of claim 3 in which the polyisocyanate is a cycloaliphatic diisocyanate.

11. The method of claim 3 in which the poly(urethane-carbonate) is prepared by reacting an isocyanate prepolymer comprising the reaction product of:
(a) a polyisocyanate,
(b) a polycarbonate diol,
(c) an isocyanate group reactive compound comprising one or more ionic groups or potential ionic groups per molecule,
(d) a chain extender that is reactive with isocyanate groups, and
(e) optionally a neutralizing agent that reacts with potential ionic groups of the poly(urethane-carbonate) to form ionic groups.

12. The method of claim 11 in which the reaction product is prepared in aqueous medium.

13. The method of claim 11 in which the polyisocyanate is a cycloaliphatic diisocyanate.

14. The method of claim 11 in which the chain extender is a cycloaliphatic diamine.

15. The method of claim 11 in which the chain extender is isophorone diamine.

16. The method of claim 11 in which the poly(urethane-carbonate) has a number average molecular weight of at least 15,000.

17. The method of claim 1 in which the electrodeposition bath is substantially free of bisphenol A and derivatives thereof.

18. The method of claim 1 in which the coated metal sheet is taken from the point of accumulation, cut into metal blanks and the blanks formed into a food or beverage can or portion thereof.

19. The method of claim 18 wherein the sheet is formed into a can end or a can body.

20. The method of claim 18 wherein the can is a two-piece drawn food or beverage can, a three-piece food or beverage can, a food or beverage can end, a drawn and ironed food or beverage can.
